(19) United States
(12) Patent Application Publication
(10) Pub. No.: US 2025/0199807 A1
(43) Pub. Date: Jun. 19, 2025

(54) SEMICONDUCTOR DEVICE, DEBUGGING SYSTEM, CONTROL METHOD FOR SEMICONDUCTOR DEVICE, AND DEBUGGING METHOD

(71) Applicant: Renesas Electronics Corporation, Tokyo (JP)

(72) Inventors: Hirofumi HATAHARA, Tokyo (JP); Shinichi NAGAI, Tokyo (JP); Tadashi HASHIMOTO, Tokyo (JP); Masahide MATSUMOTO, Tokyo (JP)

(21) Appl. No.: 18/918,198

(22) Filed: Oct. 17, 2024

(30) Foreign Application Priority Data
Dec. 13, 2023 (JP) 2023-209862

(51) Int. Cl. G06F 9/30

(52) U.S. Cl. CPC G06F 9/30058; G06F 9/30134

(57) ABSTRACT

A semiconductor device includes a CPU configured to execute an instruction, a first register configured to store an address of the instruction currently being executed, a second register configured to store a return address when a function branch occurs, and a generation circuit configured to generate and output function branch information indicating an address of a function branch destination when the function branch occurs. The generation circuit is configured to determine whether or not the function branch has occurred based on values of the first register and the second register before and after instruction execution by the CPU, and, when determining that the function branch has occurred, output the value of the first register after the instruction execution by the CPU as the function branch information.

### CROSS-REFERENCE TO RELATED APPLICATIONS

The disclosure of Japanese Patent Application No. 2023-209862 filed on Dec. 13, 2023 including the specification, drawings and abstract is incorporated herein by reference in its entirety.

### BACKGROUND

The present invention relates to a semiconductor device, a debugging system, a control method for a semiconductor device, and a debugging method, and is suitable for use in a semiconductor device on which a Central Processing Unit (CPU) is mounted, for example.

There is a demand for checking a function execution history of functions executed by a CPU mounted on a semiconductor device. As a technique for recording the function execution history of a computer such as a CPU, for example, there is a technique disclosed in Patent Document 1.

There are disclosed techniques listed below.

[Patent Document 1] Japanese Unexamined Patent Application Publication No. 2009-009201

According to the technique disclosed in Patent Document 1, a debugger initially stores, in an ID memory, instruction addresses of instructions included in a program to be debugged and function identifiers (IDs) corresponding to the instruction addresses. When the computer starts executing a program, the debugger reads the function ID corresponding to the instruction address of the instruction for each instruction from the ID memory and compares the current function ID to the previous function ID. When the current function ID is different from the previous function ID, the debugger records the current function ID in a trace memory. This allows the function execution history of the computer to be recorded.

### SUMMARY

However, there has been a problem in that the technique disclosed in Patent Document 1 requires an ID memory to store instruction addresses and function IDs, and when the ID memory is mounted onto the semiconductor device, the cost of the semiconductor device increases. Other objects and novel features will become apparent from the description of the present specification and the accompanying drawings.

According to one embodiment, a semiconductor device includes a Central Processing Unit (CPU) configured to execute an instruction included in a program, a first register configured to store an address of the instruction currently being executed by the CPU, a second register configured to store a return address when a function branch occurs by execution of the instruction by the CPU, and a generation circuit configured to generate and output function branch information indicating an address of a function branch destination when the function branch occurs by execution of the instruction by the CPU. The generation circuit is configured to determine whether or not the function branch has occurred based on values of the first register and the second register before and after instruction execution by the CPU, and, when determining that the function branch has occurred, output the value of the first register after the instruction execution by the CPU as the function branch information.

According to one embodiment, a debugging system includes the semiconductor device, an emulator configured to add a time stamp to the function branch information output from the semiconductor device and output the function branch information to which the time stamp is added, and a debugger configured to display an execution history of a function executed by the CPU based on the function branch information output from the emulator, to which the time stamp is added.

According to one embodiment, provided is a control method for a semiconductor device, in which the semiconductor device includes a Central Processing Unit (CPU) configured to execute an instruction included in a program, a first register configured to store an address of the instruction currently being executed by the CPU, and a second register configured to store a return address when a function branch occurs by execution of the instruction by the CPU. The control method includes determining whether or not the function branch has occurred based on values of the first register and the second register before and after the instruction execution by the CPU, and, when determining that the function branch has occurred, outputting the value of the first register after the instruction execution by the CPU as function branch information indicating an address of a function branch destination.

According to one embodiment, provided is a debugging method executed by a debugging system, in which the debugging system includes a semiconductor device including a Central Processing Unit (CPU) configured to execute an instruction included in a program, a first register configured to store an address of the instruction currently being executed by the CPU, and a second register configured to store a return address when a function branch occurs by execution of the instruction by the CPU, an emulator, and a debugger. The debugging method includes the semiconductor device determining whether or not the function branch has occurred based on values of the first register and the second register before and after the instruction execution by the CPU, when determining that the function branch has occurred, the semiconductor device outputting the value of the first register after the instruction execution by the CPU as function branch information indicating an address of a function branch destination, an emulator adding a time stamp to the function branch information output from the semiconductor device and outputting the function branch information to which the time stamp is added, and a debugger displaying an execution history of a function executed by the CPU based on the function branch information output from the emulator, to which the time stamp is added.

According to the one embodiment, a semiconductor device, a debugging system, a control method for the semiconductor device, and a debugging method that can check the function execution history of a CPU mounted on the semiconductor device can be provided while reducing the cost of the semiconductor device.

### BRIEF DESCRIPTION OF THE DRAWINGS

FIG. 1 is a diagram illustrating a configuration example of a debugging system according to a first embodiment.

FIG. 2 is a diagram for illustrating a schematic operation example when a function call and a function return occur in the semiconductor device according to the first embodiment.

FIG. 3 is a diagram illustrating an example of a function execution history displayed by the debugger according to the first embodiment.

FIG. 4 is a diagram for illustrating a schematic operation example of an exception call determination operation and an exception return determination operation executed by a generation circuit according to the first embodiment.

FIG. 5 is a diagram illustrating a configuration example of the generation circuit according to the first embodiment.

FIG. 6 is a diagram for illustrating an operation example when a function call and a function return occur in the CPU according to the first embodiment.

FIG. 7 is a diagram for illustrating an operation example when the function call and the function return occur in the generation circuit according to the first embodiment.

FIG. 8 is a diagram illustrating an example of an operation flow of the generation circuit according to the first embodiment.

FIG. 9 is a diagram illustrating a configuration example of a debugging system according to a modification example of the first embodiment.

FIG. 10 is a diagram illustrating a configuration example of a debugging system according to a second embodiment.

### DETAILED DESCRIPTION

Hereinafter, embodiments will be described with reference to the drawings. It should be noted that the drawings are simplified; therefore, the technical scope of the embodiments should not be interpreted narrowly based on the contents of the drawings. Also, the same elements are denoted by the same reference numerals and duplicated descriptions will be omitted.

Also, in the following embodiments, the description will be divided into a plurality of sections or embodiments when necessary for convenience. However, unless explicitly stated otherwise, they are not irrelevant to each other; rather, one may be a modification example, an application example, a detailed description, a supplementary description, etc. of another, either in part or in whole. Further, in the following embodiments, when referring to the number of elements (including quantity, numerical values, amounts, ranges, etc.), unless explicitly stated otherwise or when it is clearly restricted to a specific number in principle, the reference is not limited to that specific number but may be either more or less than that specific number.

Furthermore, in the following embodiments, the components (including operation steps, etc.) are not necessarily essential, except in cases where it is explicitly stated otherwise or where it is clearly considered essential by principle. Similarly, in the following embodiments, when referring to shapes, positional relationships, etc., of components, unless explicitly stated otherwise or where it is clearly considered not to be the case by principle, it is to be understood as including those that are substantially similar to or approximate the described shape, etc. This applies similarly to the above numerical values (including quantity, numerical values, amounts, ranges, etc.), etc.

### First Embodiment

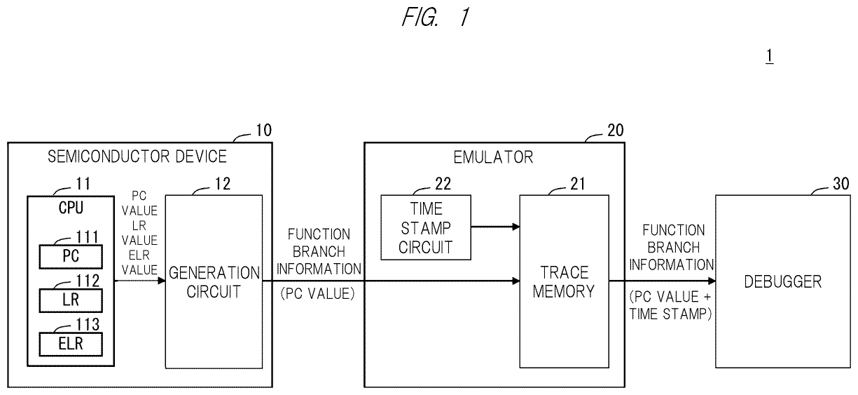

First, referring to FIG. 1, a configuration example of a debugging according to a first embodiment will be described. FIG. 1 is a block diagram illustrating a configuration of a debugging system 1 according to a first embodiment. As illustrated in FIG. 1, the debugging system 1 according to the first embodiment includes a semiconductor device 10, an emulator 20, and a debugger 30.

The semiconductor device 10 includes a CPU 11 and a generation circuit 12. The semiconductor device 10 is implemented by a System On Chip (SoC) or a Micro Processing Unit (MPU) or the like.

The CPU 11 executes instructions contained in a program to be debugged. The CPU 11 includes a program counter 111, a link register 112, and an exception link register 113. In the drawing, the program counter is appropriately denoted as PC, the link register is appropriately denoted as LR, and the exception link register is appropriately denoted as ELR.

The program counter 111 is a register that stores an address of the instruction currently being executed by the CPU 11. A link resister 112 is a register that stores a return address when a function is called by execution of the instruction by the CPU 11. The exception link register 113 is a register stores a return address when an exception occurs by that execution of the instruction by the CPU 11.

Before executing the instruction, the CPU 11 outputs values of the program counter 111, the link register 112, and the exception link register 113 before instruction execution, to the generation circuit 12. Also, after executing the instruction, the CPU 11 outputs values of the program counter 111, the link register 112, and the exception link register 113 after instruction execution, to the generation circuit 12.

The generation circuit 12 generates and outputs function branch information that indicates an address of a function branch destination when a function branch occurs by execution of the instruction by the CPU 11. Here, a function branch refers to an operation that indicates a processing transition on a function basis and an exception basis. In the first embodiment, the generation circuit 12 detects a function call, a function return, an exception call, and an exception return as function branches.

Specifically, the generation circuit 12 determines whether or not a function branch has occurred based on the values of the program counter 111, the link register 112, and the exception link register 113 before and after the instruction execution by the CPU.

When determining that a function branch has occurred, the generation unit 12 outputs the value of the program counter 111 after execution of the instruction by the CPU, to the emulator as the function branch information.

The emulator 20 includes a trace memory 21 and a time stamp circuit 22. The time stamp circuit 22 adds time stamp information to the function branch information at the timing when the function branch information is input from the generation circuit 12 of the semiconductor device 10. The trace memory 21 stores the function branch information to which the time stamp information has been added. The function branch information to which the time stamp information is added, which is stored in the trace memory 21, is output to the debugger 30.

The debugger 30 displays on a display (not illustrated) a function execution history of the functions executed by the CPU 11 based on the function branch information to which the time stamp information is added, which is output from the trace memory 21 of the emulator 20.

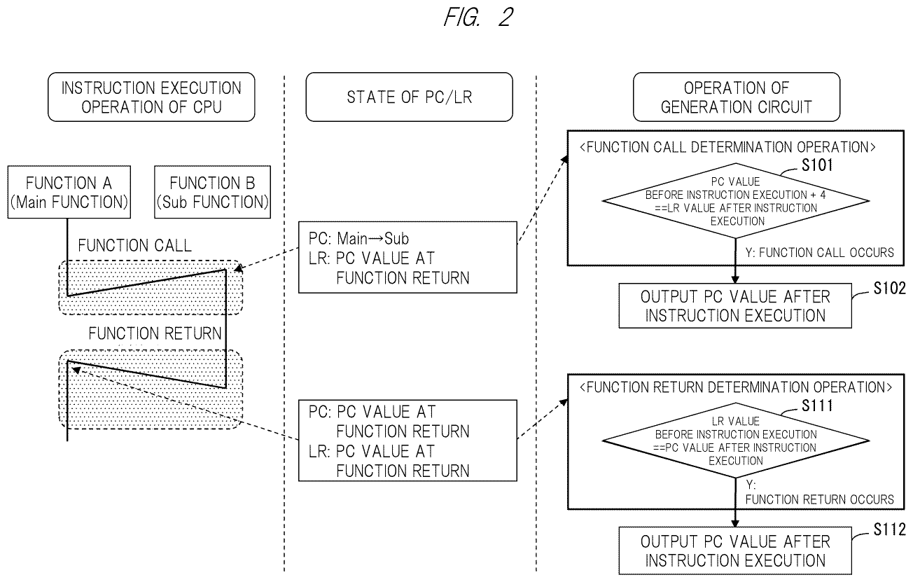

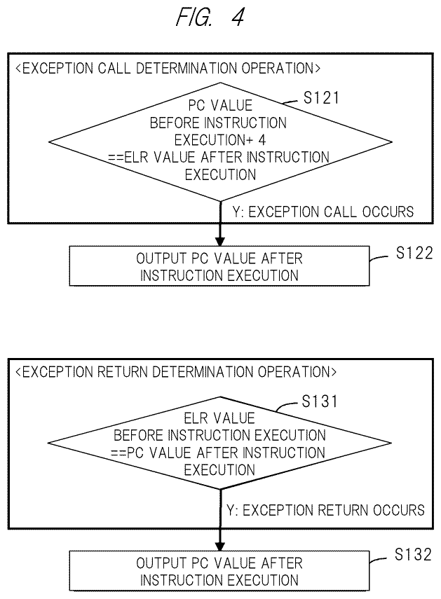

Next, with reference to FIG. 2, a schematic operation example when a function call and a function return occur in the semiconductor device 10 will be described. FIG. 2 is a diagram for describing the schematic operation example when a function call and a function return occur in the semiconductor device 10 according to the first embodiment. In FIG. 2, “Y” indicates “Yes” (the same applies to FIG. 4).

In the example of FIG. 2, execution of an instruction by the CPU 11 causes a function call in which a sub function, function B, branches from a main function, function A. At this point, the value of the program counter 111 is the address of function A before the instruction execution, and is the address of function B after the instruction execution.

Further, in an operation of the function call, the CPU 11 causes function B to branch from function A and simultaneously stores, in the link register 112, an added value obtained by adding a value of an instruction length to the value of the program counter 111 before the instruction execution. That is, the CPU 11 stores an address of a next instruction below the current instruction in function A in the link register 112.

Accordingly, the value of the link register 112 after the instruction execution becomes equivalent to the value of the program counter 111 when it returns to function A in a subsequent function return. In the following description, although the instruction length is assumed to be “4”, the instruction length is not limited to “4” and can be set to other values.

Thus, in the example of FIG. 2, execution of the instruction by the CPU 11 results in a function call occurring as a function branch. Therefore, the generation circuit 12 performs a function call determination operation illustrated in FIG. 2 to determine whether or not a function call has occurred.

In the function determination operation, the generation circuit 12 compares the added value obtained by adding the value of the instruction length “4” to the value of the program counter 111 before the instruction execution to the value of the link register 112 after the instruction execution (Step S101). If both match (Y in Step S101), the generation circuit 12 determines that a function call has occurred. In this case, both match; therefore, the generation circuit 12 determines that a function call has occurred.

When determining that a function call has occurred by the above-described function call determination operation, the generation circuit 12 outputs the value of the program counter 111 after the instruction execution to the emulator 20 as the function branch information (Step S102).

Further, in the example of FIG. 2, subsequently, execution of the instruction by the CPU 11 causes a function return in which a main function, function A branches from a sub function, function B.

In an operation of the function return, before function A branches from function B, the CPU 11 stores the value of the link register 112 in the program counter 111. Then, the CPU 11 causes function A to branch from function B.

As a result, the values of the program counter 111 and the link register 112 after the instruction execution both become values equivalent to the value of the program counter 111 when it returns to function A.

Accordingly, in the example of FIG. 2, execution of the instruction by the CPU 11 causes a function return to occur as a function branch. Therefore, the generation circuit 12 performs a function return determination operation illustrated in FIG. 2 to determine whether or not a function return has occurred.

In the function return determination operation, the generation circuit 12 compares the value of the link register 112 before the instruction execution to the value of the program counter 111 after the instruction execution (Step S111). If both match (Y in Step S111), the generation circuit 12 determines that a function return has occurred. Here, both match; therefore, the generation circuit 12 determines that a function return has

When determining that a function return has occurred by the above-described function return determination operation, the generation circuit 12 outputs the value of the program counter 111 after the instruction execution to the emulator 20 as the function branch information (Step S112).

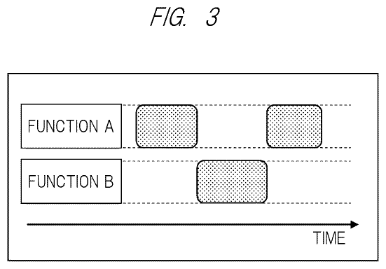

Here, an example will be described in which the function execution history of the CPU 11 displayed by the debugger 30 in the case of the example of FIG. 2. FIG. 3 is a diagram illustrating an example of a function execution history displayed by the debugger 30 according to the first embodiment. According to FIG. 3, it can be confirmed that the CPU 11 executes function A, function B, and function A in this order in chronological order.

Although not illustrated in the example of FIG. 2, execution of an instruction by the CPU 11 may result in, as a function branch, an exception call in which an exception branches from a main function, function A, or an exception return in which the main function, function A, branches from the exception.

FIG. 4 is a diagram for illustrating a schematic operation example of an exception call determination operation and an exception return determination operation executed by the generation circuit 12 according to the first embodiment. As illustrated in FIG. 4, the generation circuit 12 performs the exception call determination operation and the exception return determination operation to determine whether or not an exception call or an exception return has occurred.

In the exception call determination operation, the generation circuit 12 compares the added value obtained by adding the value of the instruction length “4” to the value of the program counter 111 before the instruction execution to the value of the exception link register 113 after the instruction execution (Step S121). If both match (Y in Step S121), the generation circuit 12 determines that an exception call has

When determining that an exception call has occurred by the above-described exception call determination operation, the generation circuit 12 outputs the value of the program counter 111 after the instruction execution to the emulator 20 as the function branch information (Step S122).

In the exception return determination operation, the generation circuit 12 compares the value of the exception link register 113 before the instruction execution to the value of the program counter 111 after the instruction execution (Step S131). If both match (Y in Step S131), the generation circuit 12 determines that an exception return has occurred.

When determining that an exception return has occurred by the above-described exception return determination operation, the generation circuit 12 outputs the value of the program counter 111 after the instruction execution to the emulator 20 as the function branch information (Step S132).

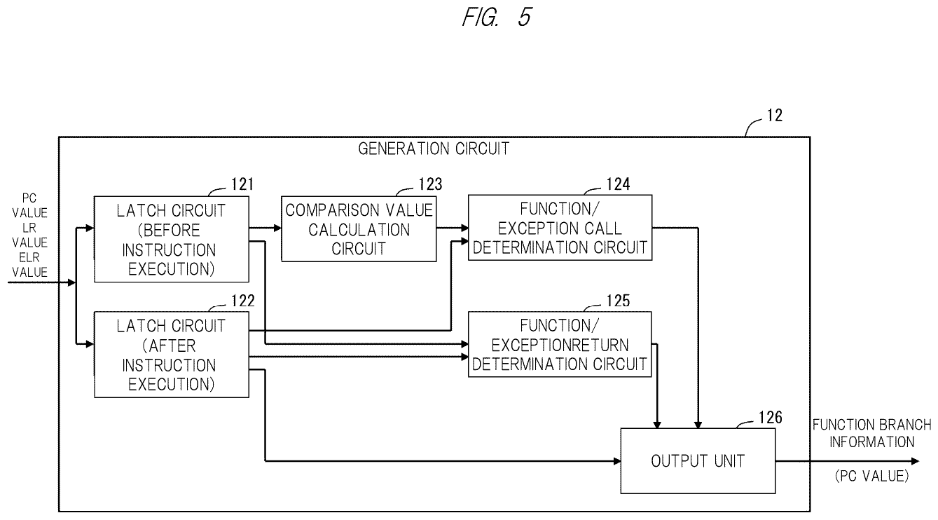

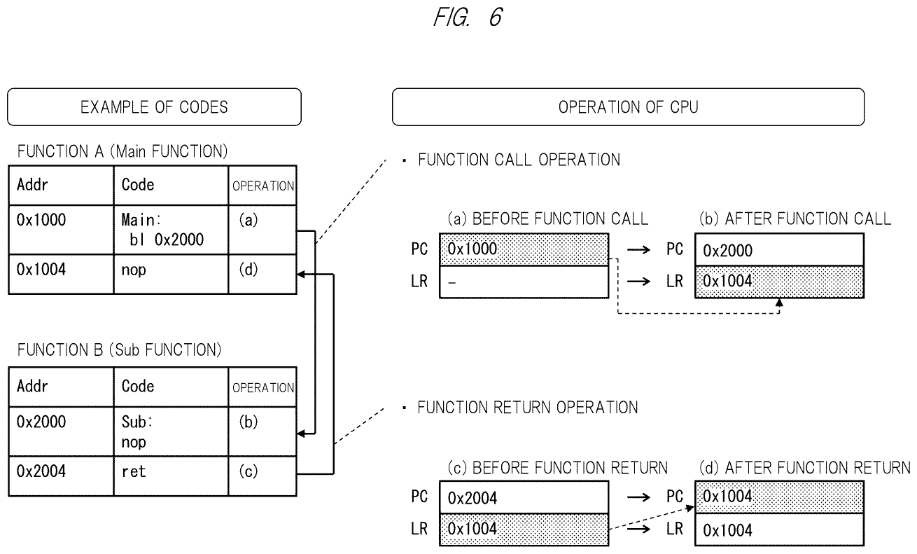

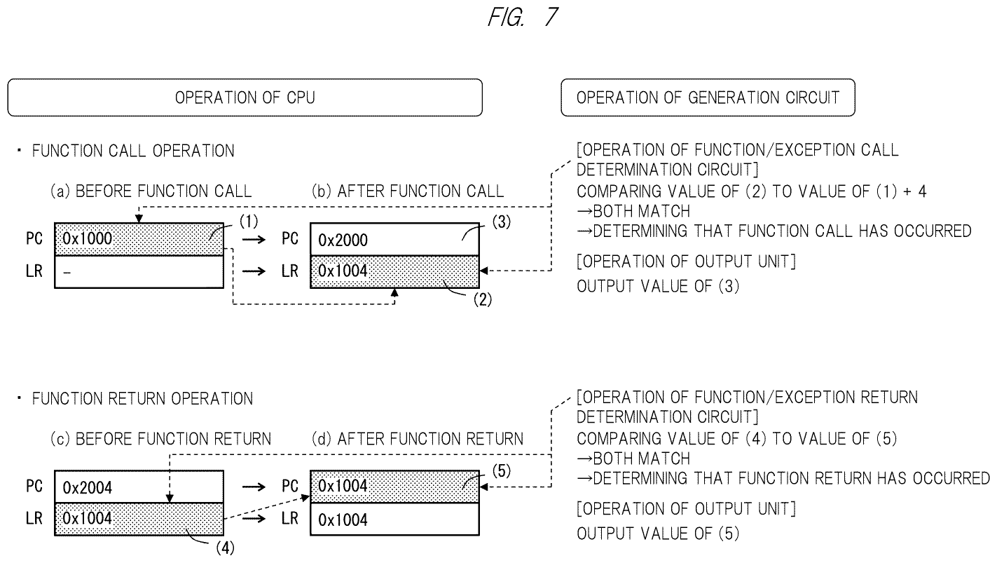

Next, a configuration example and an operation example of the semiconductor device 10 will be described in further detail with reference to FIGS. 5 to 7. FIG. 5 is a diagram illustrating the configuration example of the generation circuit 12 according to the first embodiment. FIG. 6 is a diagram for illustrating an operation example when a function call and a function return occur in the CPU 11 according to the first embodiment. FIG. 7 is a diagram for illustrating an operation example when a function call and a function return occur in the generation circuit 12 according to the first embodiment.

First, with reference to FIG. 5, the configuration example of the generation circuit 12 will be described. As illustrated in FIG. 5, the generation circuit 12 includes latch circuits 121, 122, a comparison value calculation circuit 123, a function/exception call determination circuit 124, a function/exception return determination circuit 125, and an output unit 126.

As described above, before executing the instruction, the CPU 11 outputs the values of the program counter 111, the link register 112, and the exception link register 113 before the instruction execution, to the generation circuit 12. After executing the instruction, the CPU 11 outputs the values of the program counter 111, the link register 112, and the exception link register 113 after the instruction execution, to the generation circuit 12.

When the values of the program counter 111, the link register 112, and the exception link register 113 before the instruction execution are output from the CPU 11, the latch circuit 121 holds the values.

When the values of the program counter 111, the link register 112, and the exception link register 113 after the instruction execution are output from the CPU 11, the latch circuit 122 holds the values.

The comparison value calculation circuit 123 calculates an added value by adding the value of the instruction length “4” to the value of the program counter 111 before the instruction execution held in the latch circuit 121, and holds the calculated added value.

The function/exception call determination circuit 124 performs the above-mentioned function call determination operation and the exception call determination operation using the value held by the comparison value calculation circuit 123 and the values of the link register 112 and the exception link register 113 after the instruction execution held in the latch circuit 122.

In the function call determination operation, the function/exception call determination circuit 124 compares the value held by the comparison value calculation circuit 123 to the value of the link register 112 after the instruction execution, and if both match, the function/exception call determination circuit 124 determines that a function call has

Also, in the exception call determination operation, the function/exception call determination circuit 124 compares the value held by the comparison value calculation circuit 123 to the value of the exception link register 113 after the instruction execution, and if both match, the function/exception call determination circuit 124 determines that an exception call has occurred.

The function/exception call determination circuit 124 outputs a determination result indicating whether or not a function call or an exception call has occurred to the output unit 126.

The function/exception return determination circuit 125 performs the above-mentioned function return determination operation and the exception return determination operation using the values of the link register 112 and the exception link register 113 before the instruction execution held in the latch circuit 121 and the value of the program counter 111 after the instruction execution held in the latch circuit 122.

In the function return determination operation, the function/exception return determination circuit 125 compares the value of the link register 112 before the instruction execution to the value of the program counter 111 after the instruction execution, and if both match, the function/exception return determination circuit 125 determines that a function return has occurred.

Also, in the exception return determination operation, the function/exception return determination circuit 125 compares the value of the exception link register 113 before the instruction execution to the value of the program counter 111 after the instruction execution, and if both match, the function/exception return determination circuit 125 determines that an exception return has occurred.

The function/exception return determination circuit 125 outputs a determination result indicating whether or not a function return or an exception return has occurred to the output unit 126.

The output unit 126 determines whether or not a function branch of any of a function call, an exception call, a function return, or an exception return has occurred, based on the determination results output from the function/exception call determination circuit 124 and the function/exception return determination circuit 125. When determining that any function branch has occurred, the output unit 126 outputs the value of the program counter 111 after the instruction execution held in the latch circuit 122 to the emulator 20 as the function branch information.

Next, with reference to FIGS. 6 and 7, an operation example of the semiconductor device 10 will be described. First, with reference to FIG. 6, an operation example when a function call and a function return occur in the CPU 11 will be described.

001 FIG. 6 illustrates addresses and codes of instructions executed for the main function, function A, and also illustrates addresses and codes of instructions executed for the sub function, function B. Also, in the example of FIGS. 6 and 7, similar to FIG. 2, a function call occurs in which the sub function, function B, branches from the main function, function A, and, subsequently, a function return occurs in which the main function, function A, branches from the sub-function, function B.

In the initial state, the value of the program counter 111 (the value before the instruction execution) is “0x1000”. Therefore, the CPU 11 executes the instruction at address “0x1000” (operation (a)). At this point, the instruction at address “0x1000” includes a function call instruction (bl instruction). The bl instruction is an instruction that calls the function located at address “0x2000”.

Therefore, the CPU 11 executes an operation of a function call in which function B branches from function A. In the operation of a function call, the CPU 11 causes function B to branch from function A and simultaneously stores the address of the next instruction below the current instruction in the link register 112. In this case, the instruction length is “4”; therefore, the address of the next instruction below the address of the current instruction “0x1000” is “0x1004”, in which the instruction length “4” is added to the address of the current instruction “0x1000”. Therefore, the CPU 11 stores “0x1004” in the link register 112. As a result, the value of the link register 112 after the instruction execution of the function call becomes a value equivalent to the value of program counter 111 when it returns to function A in the subsequent function return.

Here, the value of the program counter 111 after the instruction execution of the function call is the address of function B, “0x2000”. Therefore, the CPU 11 executes the instruction at address “0x2000” (operation (b)). At this point, the instruction at address “0x2000” includes a no-operation instruction (nop instruction). Accordingly, after executing the nop instruction, the CPU 11 changes the value of the program counter 111 to the location address of the next instruction. As a result, the value of the program counter 111 becomes “0x2004”.

Next, the CPU 11 executes the next instruction below, that is, the instruction at address “0x2004” (operation (c)). At this point, the instruction at address “0x2004” includes a function return instruction (ret instruction).

Accordingly, the CPU 11 executes an operation of a function return in which function A branches from function B. In the operation of a function return, before causing function A to branch from function B, the CPU 11 stores the value “0x1004” of the link register 112 in the program counter 111. Then, the CPU 11 causes function A to branch from function B.

Here, the value of the program counter 111 after the instruction execution of the function return is the address of function A, “0x1004”. Therefore, the CPU 11 executes the instruction at address “0x1004” (operation (d)). At this point, the instruction at address “0x1004” includes a nop instruction. Accordingly, the CPU 11 executes the nop instruction.

Next, with reference to FIG. 7, an operation example when a function call and a function return occur in the generation circuit 12 will be described. The operation example of the CPU 11 illustrated in FIG. 7 is similar to the operation example of the CPU 11 illustrated in FIG. 6.

As illustrated in FIG. 7, whether or not a function call has occurred is determined by the function/exception call determination circuit 124 executing a function call determination operation. Here, the comparison value calculation circuit 123 holds a value “0x1004” obtained by adding the value of the instruction length “4” to the value “0x1000” of the program counter 111 at (1) before the instruction execution of the function call.

Accordingly, in the function call determination operation, the function/exception call determination circuit 124 compares the value “0x1004” of the link register 112 at (2) after the instruction execution of the function call to the value “0x1004” held by the comparison value calculation circuit 123. In this case, both match; therefore, the function/exception call determination circuit 124 determines that a function call has occurred.

Due to this, the output unit 126 outputs the value of the program counter 111 at (3) after the instruction execution of the function call, “0x2000”, to the emulator 20 as the function branch information.

Also, whether or not a function return has occurred is determined by the function/exception return determination circuit 125 executing the function return determination operation. In the function determination return operation, the function/exception return determination circuit 125 compares the value of the link register 112 at (4) before the instruction execution of the function return, “0x1004”, to the value of the program counter 111 at (5) after the instruction execution of the function return, “0x1004”. In this case, both match; therefore, the function/exception return determination circuit 125 determines that a function return has occurred.

Accordingly, the output unit 126 outputs the value of the program counter 111 at (5) after the instruction execution of the function return, “0x1004”, to the emulator 20 as the function branch information.

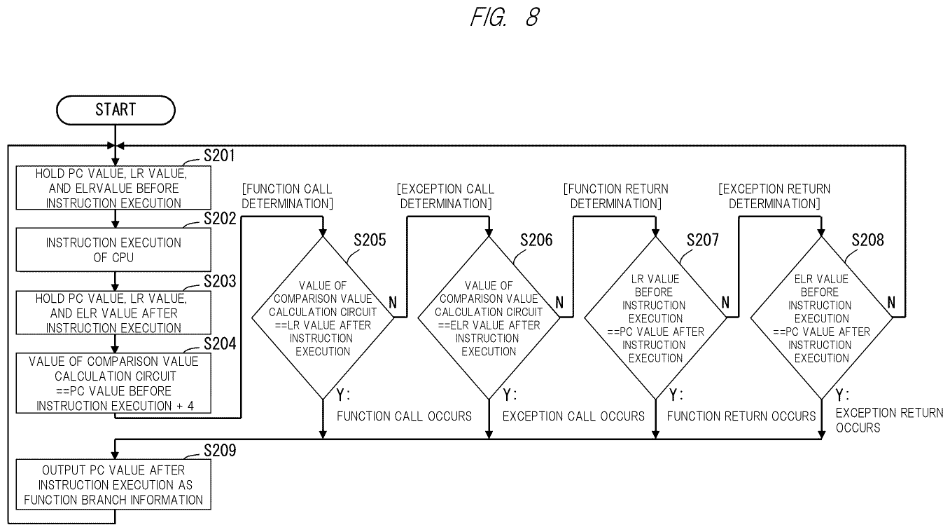

Next, with reference to FIG. 8, an example of an operation flow of the generation circuit 12 will be described. FIG. 8 is a diagram illustrating an example of the operation flow of the generation circuit 12 according to the first embodiment. In FIG. 8, “Y” indicates “Yes” and “N” indicates “No”. As illustrated in FIG. 8, the latch circuit 121 holds the values of the program counter 111, the link register 112, and the exception link register 113 before the execution of the instruction by the CPU 11 (Step S201).

When the instruction has been executed by the CPU 11 (Step S202), the latch circuit 122 holds the values of the program counter 111, the link register 112, and the exception link register 113 after the execution of the instruction by the CPU (Step S203).

Next, the comparison value calculation circuit 123 calculates an added value by adding the value of the instruction “4” to the value of the program counter 111 before the instruction execution held in the latch circuit 121, and holds the calculated added value (Step S204).

Next, the function call determination operation is performed. Specifically, the function/exception call determination circuit 124 compares the value held by the comparison value calculation circuit 123 to the value of the link register 112 after the instruction execution held in the latch circuit 122 (Step S205). If both match (Y in Step S205), the function/exception call determination circuit 124 determines that a function call has occurred.

Next, the exception call determination operation is performed. Specifically, the function/exception call determination circuit 124 compares the value held by the comparison value calculation circuit 123 to the value of the exception link register 113 after the instruction execution held in the latch circuit 122 (Step S206). If both match (Y in Step S206), the function/exception call determination circuit 124 determines that an exception call has occurred.

Next, the function return determination operation is performed. Specifically, the function/exception return determination circuit 125 compares the value of the link register 112 before the instruction execution held in the latch circuit 121 to the value of the program counter 111 after the instruction execution held in the latch circuit 122 (Step S207). If both match (Y in Step S207), the function/exception return determination circuit 125 determines that a function return has occurred.

Next, the exception return determination operation is performed. Specifically, the function/exception return determination circuit 125 compares the value of the exception link register 113 before the instruction execution held in the latch circuit 121 to the value of the program counter 111 after the instruction execution held in the latch circuit 122 (Step S208). If both match (Y in Step S208), the function/exception return determination circuit 125 determines that an exception return has occurred.

The output unit 126 determines whether or not it has been determined that a function branch of any of a function call, an exception call, a function return, or an exception return has occurred in any one of Steps S205 to S208. When it is determined that any function branch has occurred, the output unit 126 outputs the value of the program counter 111 after the instruction execution held in the latch circuit 122 to the emulator 20 as the function branch information (Step S209).

As described above, according to the first embodiment, the semiconductor device 10 determines whether or not a function branch has occurred based on the values of the program counter 111, the link register 112, and the exception link register 113 before and after the instruction execution. When determining that a function branch has occurred, the semiconductor device 10 outputs the value of the program counter 111 after the instruction execution as the function branch information. Therefore, the semiconductor device 10 does not require an ID memory, which is necessary in Patent Document 1, and therefore an increase in the cost of the semiconductor device 10 due to the incorporation of an ID memory can be avoided. Consequently, the function execution history of the CPU 11 mounted on the semiconductor device 10 can be checked while reducing the cost of the semiconductor device 10.

### Modification Example of First Embodiment

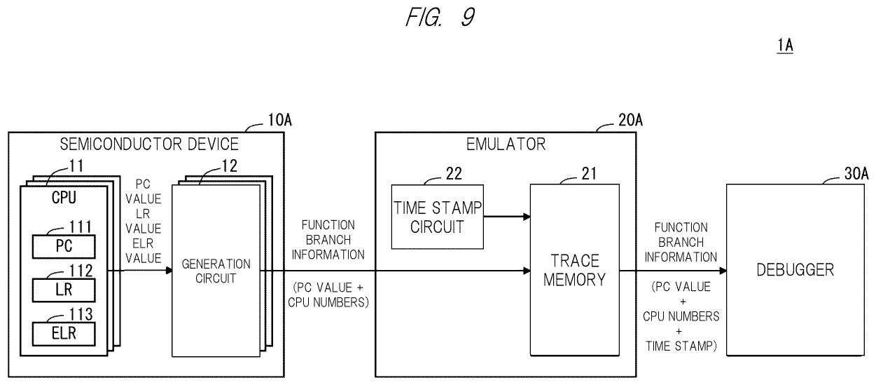

Next, with reference to FIG. 9, a configuration example of a debugging system according to a modification example of the first embodiment will be described. FIG. 9 is a diagram illustrating a configuration example of a debugging system 1A according to the modification example of the first embodiment. The modification example is an example in which a plurality of CPUS 11 are mounted on a semiconductor device 10A.

As illustrated in FIG. 9, the debugging system 1A according to the modification example includes the semiconductor device 10A, an emulator 20A, and a debugger 30A. The semiconductor device 10A differs from the semiconductor device 10 described above in that the semiconductor device 10A includes the plurality of above-described CPUs 11 and a plurality of above-described generation circuits 12.

Each of the plurality of generation circuits 12 is provided in association with one of the plurality of CPUs 11. Further, each of the plurality of CPUs 11 is associated with a CPU number as a number for identifying the CPU. When determining that a function branch has occurred after executing an instruction by an associated CPU 11, each of the plurality of generation circuits 12 adds the CPU number of the associated CPU 11 to the function branch information and outputs the function branch information, to which the CPU number is added, to the emulator 20A.

The emulator 20A has a similar configuration to the emulator 20 described above. The time stamp circuit 22 adds the time stamp information to the function branch information to which the CPU numbers have been added, at the timing when the function branch information to which the CPU numbers have been added is input from the generation circuits 12 of the semiconductor device 10A. The trace memory 21 stores the function branch information to which the CPU numbers and the time stamp information are added. The function branch information, to which the CPU numbers and the time stamp information are added and which is stored in the trace memory 21, is output to the debugger 30A.

The debugger 30A displays the function execution history of each CPU 11 on a display (not illustrated) based on the function branch information, which is output from the trace memory 21 of the emulator 20A, to which the CPU numbers and the time stamp information are added.

As described above, according to the present modification example, as with the semiconductor device 10 described above, the semiconductor device 10A does not require the ID memory that is necessary in Patent Document 1, and therefore an increase in the cost of the semiconductor device 10A due to the incorporation of an ID memory can be avoided. Furthermore, the function branch information output from the semiconductor device 10A is limited to the function branches related to a function call, a function return, an exception call, and an exception return; therefore, information on other types of function branches other than the above, such as those resulting from “if” statements or “while” statements, is not included, leading to a smaller amount of information. Due to this, the semiconductor device 10A is capable of outputting all function branch information of the plurality of CPUs 11 mounted on the semiconductor device 10A. Consequently, all of the function execution histories of the plurality of CPUs 11 mounted on the semiconductor device 10A can be checked while reducing the cost of the semiconductor device 10A.

### Second Embodiment

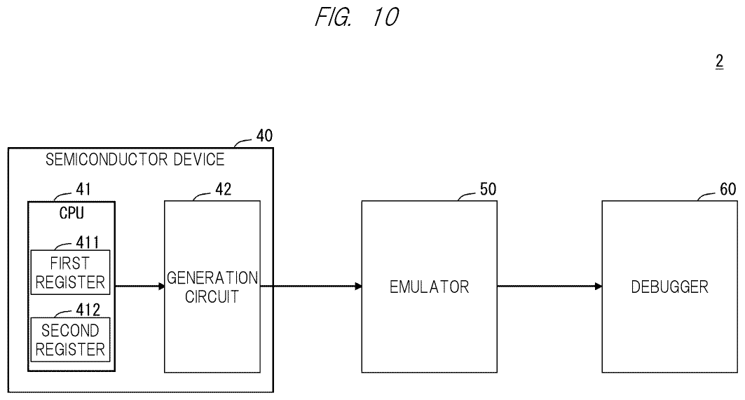

A second embodiment is an embodiment equivalent to the generalized first embodiment above. With reference to FIG. 10, a configuration example of a debugging system according to the second embodiment will be described. FIG. 10 is a diagram illustrating a configuration example of a debugging system 2 according to the second embodiment.

As illustrated in FIG. 10, the debugging system 2 according to the second embodiment includes a semiconductor device 40, an emulator 50, and a debugger 60.

The semiconductor device 40 includes a CPU 41 and a generating circuit 42. The semiconductor device 40 is equivalent to the semiconductor device 10. The CPU 41 executes an instruction included in the program to be debugged. The CPU 41 also includes a first register 411 and a second register 412. The CPU 41 is equivalent to the CPU 11.

The first register 411 stores an address of an instruction currently being executed by the CPU 41. The first register 411 is equivalent to the program counter 111. The second register 412 stores a return address when a function branch occurs by execution of the instruction by the CPU 41. The second register 412 is equivalent to the link register 112 or the exception link register 113.

The generation circuit 42 generates and outputs function branch information indicating an address of a function branch destination when a function branch occurs by execution of the instruction by the CPU 41. The generating circuit 42 is equivalent to the generating circuit 12.

Specifically, the generation circuit 42 determines whether or not a function branch has occurred based on the values of the first register 411 and the second register 412 before and after the instruction execution by the CPU 41. When determining that a function branch has occurred, the generation circuit 42 outputs the value of the first register 411 after the instruction execution by the CPU 41 to the emulator 50 as the function branch information.

The emulator 50 adds a time stamp to the function branch information output from the semiconductor device 40, and outputs the function branch information to which the time stamp is added to the debugger 60. The emulator 50 is equivalent to the emulator 20.

The debugger 60 displays a function execution history of the function executed by the CPU 41 based on the function branch information to which the time stamp is added, which is output from the emulator 50. The debugger 60 is equivalent to the debugger 30.

As described above, according to the second embodiment, the semiconductor device 40 determines whether or not a function branch has occurred based on the values of the first register 411 and the second register 412 before and after the instruction execution. When determining that a function branch has occurred, the semiconductor device 40 outputs the value of the first register 411 after the instruction execution as the function branch information. Therefore, the semiconductor device 40 does not require an ID memory, which is necessary in Patent Document 1, and therefore an increase in the cost of the semiconductor device 40 due to the incorporation of an ID memory can be avoided. Consequently, the function execution history of the CPU 41 mounted on the semiconductor device 40 can be checked while reducing the cost of the semiconductor device 10.

Furthermore, when the second register 412 is a link register, the generation circuit 42 may determine that a function call has occurred as a function branch when an added value obtained by adding a predetermined value equivalent to the instruction length to the value of the program counter before the instruction execution by the CPU 41 matches the value of the link register after the instruction execution by the CPU 41.

Furthermore, when the second register 412 is a link register, the generation circuit 42 may determine that a function return has occurred as a function branch when the value of the link register before the instruction execution by the CPU 41 matches the value of the program counter after the instruction execution by the CPU 41.

Furthermore, when the second register 412 is an exception link register, the generation circuit 42 may determine that an exception call has occurred as a function branch when an added value obtained by adding a predetermined value equivalent to the instruction length to the value of the program counter before the instruction execution by the CPU 41 matches the value of the exception link register after the instruction execution by the CPU 41.

Furthermore, when the second register 412 is an exception link register, the generation circuit 42 may determine that an exception return has occurred as a function branch when the value of the exception link register before the instruction execution by the CPU 41 matches the value of the program counter after the instruction execution by the CPU 41.

Moreover, the semiconductor device 40 may include a plurality of CPUs 41 and a plurality of generating circuits 42. That is, the semiconductor device 40 may include a plurality of first registers 411 and a plurality of second registers 412. In addition, when determining that a function branch has occurred by execution of an instruction by an associated CPU 41 and, each of the plurality of generation circuits 42 may add the CPU number of the associated CPU 11 to the function branch information and output the function branch information, to which the CPU number is added, to the emulator 50. The semiconductor device 40 may also be an SoC or an MPU.

In the foregoing, the invention made by the inventors of the present application has been concretely described on the basis of the embodiments. However, it is needless to say that the present invention is not limited to the foregoing embodiments, and various modifications and alterations can be made within the scope of the present invention.

Furthermore, in the present disclosure, part or all of the processing of the semiconductor device 10, 10A, 40, the emulator 20, 20A, 50, and the debugger 30, 30A, 60 can be implemented by causing the CPU to execute a computer program.

Moreover, the above-mentioned program includes a set of instructions (or software code) that, when loaded into a computer, causes the computer to perform one or more functions described in the embodiments. The program may be stored in a non-transitory computer-readable medium or a tangible storage medium. By way of example, and not limitation, a computer-readable medium or a tangible storage medium includes a Random-Access Memory (RAM), a Read-Only Memory (ROM), a flash memory, a Solid-State Drive (SSD) or other memory techniques, a Compact Disc (CD)-ROM, a Digital Versatile Disc (DVD), a Blu-ray (registered trademark) disc, or other optical disc storage, a magnetic cassette, a magnetic tape, and a magnetic disk storage or other magnetic storage devices. The program may be transmitted on a transitory computer-readable medium or a communication medium. By way of example, and not limitation, a transitory computer-readable medium or a communication medium includes propagated signals in electrical, optical, acoustic, or other forms.

What is claimed is:

1. A semiconductor device comprising:
a Central Processing Unit (CPU) configured to execute an instruction included in a program;
a first register configured to store an address of the instruction currently being executed by the CPU;
a second register configured to store a return address when a function branch occurs by execution of the instruction by the CPU; and
a generation circuit configured to generate and output function branch information indicating an address of a function branch destination when the function branch occurs by execution of the instruction by the CPU,
wherein the generation circuit is configured to
determine whether or not the function branch has occurred based on values of the first register and the second register before and after instruction execution by the CPU, and,
when determining that the function branch has occurred, output the value of the first register after the instruction execution by the CPU as the function branch information.

2. The semiconductor device according to claim 1,
wherein the first register is a program counter, and
wherein the second register is a link register configured to store the return address when a function is called by execution of the instruction by the CPU, or an exception link register configured to store the return address when an exception occurs by execution of the instruction by the CPU.

3. The semiconductor device according to claim 2,
wherein, when the second register is the link register, the generation circuit is configured to determine that a function call has occurred as the function branch when an added value obtained by adding a predetermined value equivalent to an instruction length to a value of the program counter before the instruction execution by the CPU matches a value of the link register after the instruction execution by the CPU.

4. The semiconductor device according to claim 2,
wherein, when the second register is the link register, the generation circuit is configured to determine that a function return has occurred as the function branch when a value of the link register before the instruction execution by the CPU matches a value of the program counter after the instruction execution by the CPU.

5. The semiconductor device according to claim 2,
wherein, when the second register is the exception link register, the generation circuit is configured to determine that an exception call has occurred as the function branch when an added value obtained by adding a predetermined value equivalent to an instruction length to a value of the program counter before the instruction execution by the CPU matches a value of the exception link register after the instruction execution by the CPU.

6. The semiconductor device according to claim 2,
wherein, when the second register is the exception link register, the generation circuit is configured to determine that an exception return has occurred as the function branch when a value of the exception link register before the instruction execution by the CPU matches a value of the program counter after the instruction execution by the CPU.

7. The semiconductor device according to claim 1, comprising:
a plurality of the CPUs;
a plurality of the first registers;
a plurality of the second registers; and
a plurality of the generation circuits provided in association with the plurality of the CPUS,
wherein, when determining that the function branch has occurred by execution of an instruction by an associated CPU, each of the plurality of generation circuits is configured to add a CPU number of the associated CPU to the function branch information and output the function branch information, to which the CPU number is added.

8. The semiconductor device according to claim 1,
wherein the semiconductor device is a System On Chip (SoC) or a Micro Processing Unit (MPU).

9. A debugging system comprising:
the semiconductor device according to claim 1;
an emulator configured to add a time stamp to the function branch information output from the semiconductor device and output the function branch information to which the time stamp is added; and
a debugger configured to display an execution history of a function executed by the CPU based on the function branch information output from the emulator, to which the time stamp is added.

10. A control method for a semiconductor device,
wherein the semiconductor device includes
a Central Processing Unit (CPU) configured to execute an instruction included in a program,
a first register configured to store an address of the instruction currently being executed by the CPU, and
a second register configured to store a return address when a function branch occurs by execution of the instruction by the CPU,
the control method comprising:
determining whether or not the function branch has occurred based on values of the first register and the second register before and after the instruction execution by the CPU; and,
when determining that the function branch has occurred, outputting the value of the first register after the instruction execution by the CPU as function branch information indicating an address of a function branch destination.

11. The control method for the semiconductor device according to claim 10,
wherein the first register is a program counter, and
wherein the second register is a link register configured to store a return address when a function is called by execution of the instruction by the CPU, or an exception link register configured to store the return address when an exception occurs by execution of the instruction by the CPU.

12. A debugging method executed by a debugging system,
wherein the debugging system includes
a semiconductor device including a Central Processing Unit (CPU) configured to execute an instruction included in a program, a first register configured to store an address of the instruction currently being executed by the CPU, and a second register configured to store a return address when a function branch occurs by execution of the instruction by the CPU,
an emulator, and
a debugger,
the debugging method comprising:
the semiconductor device determining whether or not the function branch has occurred based on values of the first register and the second register before and after the instruction execution by the CPU;
when determining that the function branch has occurred, the semiconductor device outputting the value of the first register after the instruction execution by the CPU as function branch information indicating an address of a function branch destination;
an emulator adding a time stamp to the function branch information output from the semiconductor device and outputting the function branch information to which the time stamp is added; and
a debugger displaying an execution history of a function executed by the CPU based on the function branch information output from the emulator, to which the time stamp is added.

13. The debugging method according to claim 12,
wherein the first register is a program counter, and
wherein the second register is a link register configured to store the return address when a function is called by execution of the instruction by the CPU, or an exception link register configured to store the return address when an exception occurs by execution of the instruction by the CPU.
